(19) United States
(12) Patent Application Publication
(10) Pub. No.: US 2018/0014312 A1
(43) Pub. Date: Jan. 11, 2018

(54) BASE STATION APPARATUS AND METHOD OF ALLOCATING A RADIO RESOURCE

(71) Applicant: FUJITSU LIMITED, Kawasaki-shi (JP)

(72) Inventor: Takato EZAKI, Yokohama (JP)

(73) Assignee: FUJITSU LIMITED, Kawasaki-shi (JP)

(21) Appl. No.: 15/615,532

(22) Filed: Jun. 6, 2017

(30) Foreign Application Priority Data
Jul. 7, 2016 (JP) 2016-135073

(51) Int. Cl. H04W 72/10; H04W 72/08; H04W 72/04; H04W 88/02; H04W 72/12

(52) U.S. Cl. CPC H04W 72/10; H04W 88/02; H04W 72/1247; H04W 72/042; H04W 72/0453; H04W 72/082

(57) ABSTRACT

A base station apparatus executes a first scheduling of allocating a first radio resource in a first frequency band used in a first wireless communication standard to a first terminal device, and executes a second scheduling of allocating a second radio resource in a second frequency band used in a second wireless communication standard to a second terminal device, wherein the second frequency band is broader than the first frequency band, the first frequency band is included in the second frequency band, when the first radio resource is not allocated in the first scheduling, the first frequency band is allocated as the second radio resource in the second scheduling, and when the first radio resource is allocated in the first scheduling, a frequency band other than the first frequency band in the second frequency band is allocated as the second radio resource in the second scheduling.

### CROSS-REFERENCE TO RELATED APPLICATION

This application is based upon and claims the benefit of priority of the prior Japanese Patent Application No. 2016-135073, filed on Jul. 7, 2016, the entire contents of which are incorporated herein by reference.

### FIELD

The embodiments discussed herein are related to a base station apparatus and a method of allocating a radio resource.

### BACKGROUND

In recent years, Internet of Things (IoT) attracts attention. For example, IoT is a mechanism in which various objects are coupled to the Internet and are mutually controlled through information exchange. The “object” here includes, for example, a smartphone having an Internet Protocol (IP) address, a product detectable by a sensor with an IP address, a content stored in a device with an IP address, or the like. As an example of IoT, there is a smart meter that transmits the amount of electric power measured by a wattmeter in each household to a server or the like by using the wireless communication function of the wattmeter. It is considered that, for example, a large amount of information is smoothly distributed by IoT to improve the productivity and efficiency in a citizen's life, thereby realizing a new social system.

Third Generation Partnership Project (3GPP) develops a new standard called Narrow Band (NB)-IoT, as one of radio communication standards for IoT.

With respect to NB-IoT, 3GPP discusses three operation modes of “Stand-alone operation”, “Guard band operation”, and “In carrier operation”.

“Stand-alone operation” is, for example, a mode in which the NB-IoT carrier is operated as a single carrier. In addition, “Guard band operation” is, for example, a mode in which the NB-IoT carrier is operated on guard bands existing at both ends of a Long Term Evolution (LTE) carrier. Furthermore, “In carrier operation” is, for example, a mode in which the NB-IoT carrier is operated in the same frequency band as the LTE carrier.

For example, “Stand-alone operation” and “Guard band operation” are modes in which the NB-IoT carrier is operated in a band independent from the existing LTE carrier. Therefore, for example, using an NB-IoT carrier that is narrower than the LTE carrier in an independent band may not be suitable in terms of investment cost in some cases.

Examples of a technique relating to such wireless communication are as follows: That is, there is a technique relating to a method of directly overlapping a machine to machine (M2M) signal with an orthogonal frequency division multiple access (OFDMA), and transmitting the OFDMA signal including the M2M signal.

According to this technique, it is possible to provide a method for efficiently transmitting an M2M signal over an OFDMA-based wireless radio access network. As the related art, there are Japanese National Publication of International Patent Application No. 2013-502124, and RP-151545, “NB-LTE for Low Complexity Radio Access Network for Cellular Internet of Things”, Alcatel-Lucent et al., 3GPP RAN#69, September 2015.

### SUMMARY

According to an aspect of the invention, a base station apparatus includes a memory and a processor coupled to the memory and configured to execute a first scheduling of allocating a first radio resource in a first frequency band used in a first wireless communication standard to a first terminal device, and execute a second scheduling of allocating a second radio resource in a second frequency band used in a second wireless communication standard to a second terminal device, and wherein the second frequency band is broader than the first frequency band, and the first frequency band is included in the second frequency band, the second scheduling is executed after the first scheduling is executed, when the first radio resource is not allocated in the first scheduling, the first frequency band is allocated as the second radio resource in the second scheduling, and when the first radio resource is allocated in the first scheduling, a frequency band other than the first frequency band in the second frequency band is allocated as the second radio resource in the second scheduling.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of a wireless communication system;

FIG. 2 is a diagram illustrating a configuration example of the wireless communication system;

FIG. 3 is a diagram illustrating examples of a broad band and a narrow band;

FIG. 4 is a diagram illustrating a configuration example of a base station;

FIG. 5 is a diagram illustrating a configuration example of a narrowband terminal;

FIG. 6 is a diagram illustrating a configuration example of a broadband terminal;

FIG. 7 is a diagram illustrating an example of scheduling;

FIG. 8 is a flowchart illustrating an operation example;

FIG. 9 is a diagram illustrating examples of scheduling;

FIG. 10 is a flowchart illustrating an operation example;

FIG. 11 is a flowchart illustrating an operation example;

FIG. 12 is a diagram illustrating examples of a reception operation;

FIG. 13 is a diagram illustrating a configuration example of a base station;

FIG. 14 is a diagram illustrating a hardware configuration example of the base station;

FIG. 15 is a diagram illustrating a hardware configuration example of the base station; and

FIG. 16 is a diagram illustrating a hardware configuration example of the terminal.

### DESCRIPTION OF EMBODIMENTS

A technique of transmitting an OFDMA signal including an M2M signal has not been discussed about NB-IOT, and there is no disclosure or suggestion as to how the NB-IoT carrier is operated.

Hereinafter, modes for carrying out embodiments will be described. The following embodiments do not limit the disclosed technique. Respective embodiments can be combined appropriately as long as the processing contents do not contradict each other.

In addition, the terms and technical contents described in the specification as the standard related to communication such as 3GPP may be appropriately used for the terms and technical contents described herein.

### First Embodiment

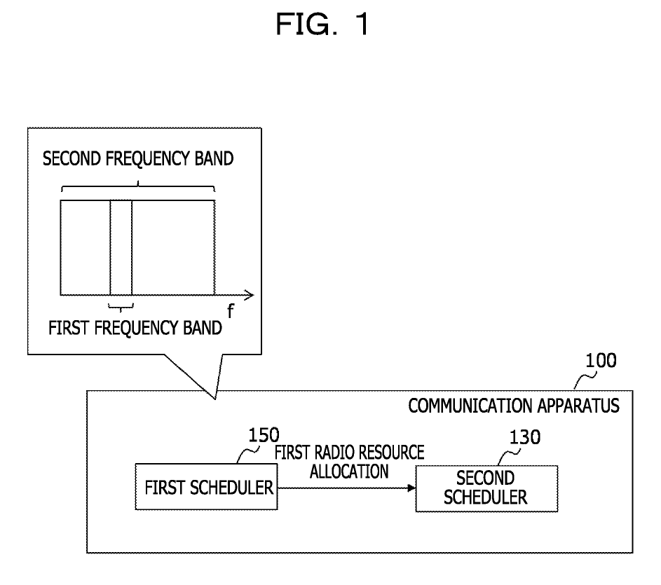

FIG. 1 is a diagram illustrating a configuration example of a communication apparatus 100 according to a first embodiment. The communication apparatus 100 includes first and second schedulers 150 and 130.

The first scheduler 150 allocates first radio resources in a first frequency band used in a first wireless communication method. On the other hand, the second scheduler 130 allocates second radio resources in a second frequency band used in a second wireless communication method. With respect to the relationship between the first frequency band and the second frequency band, the first frequency band is placed within the second frequency band.

The first scheduler 150 notifies the second scheduler 130 of the allocation of the first radio resource. In a case where the first radio resource is not allocated, the second scheduler 130 allocates the first frequency band as the second radio resource used in the second wireless communication method.

In this way, in a case where the first radio resource is not allocated, the second scheduler 130 allocates the first frequency band as the second radio resource used in the second wireless communication method, thereby dynamically adjusting the allocation of radio resources. Therefore, it is also possible to efficiently operate radio resources as the whole system.

On the other hand, in a case where the allocation of the first radio resource is notified, the second scheduler 130 allocates the second radio resource in the frequency band other than the first frequency band, out of the second frequency band, to a terminal device using the second wireless communication method.

### Second Embodiment

Next, a second embodiment will be described.

<Configuration Example of Wireless Communication System>

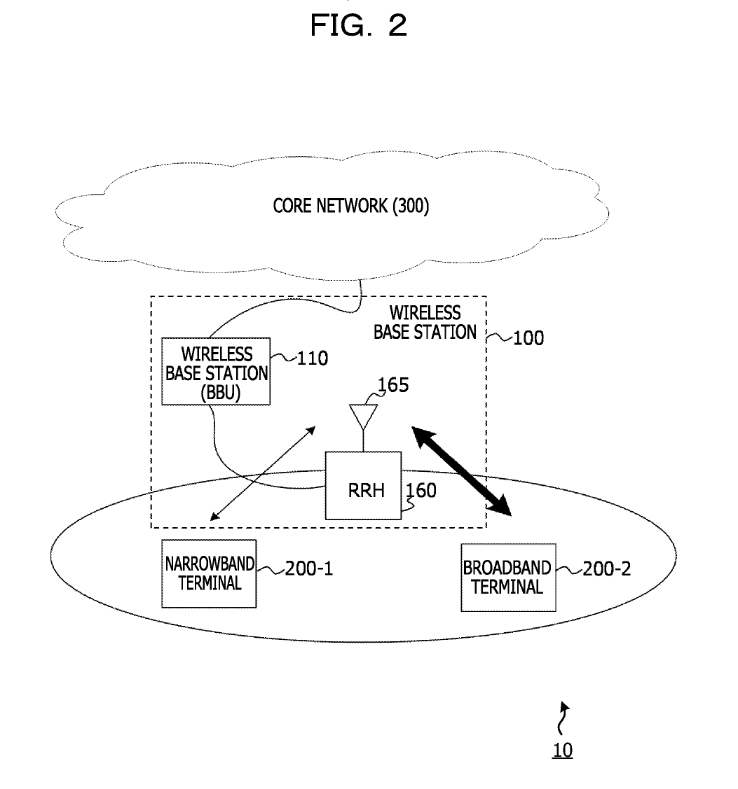

FIG. 2 illustrates a wireless communication system 10 in a second embodiment. The wireless communication system 10 includes a wireless base station apparatus (or a wireless base station, hereinafter, it may be referred to as a “base station”) 100, narrowband terminal 200-1, and a broadband terminal 200-2.

The base station 100 corresponds to, for example, the communication apparatus 100 of the first embodiment.

The base station 100 is, for example, a communication apparatus or wireless communication apparatus which provides various services such as a call service and a web browsing service to the narrowband terminal 200-1 and the broadband terminal 200-2, which are located in the service available range (or cell range) of the base station 100. Further, the base station 100 performs, for example, scheduling such as allocation of radio resources to the narrowband terminal 200-1 and the broadband terminal 200-2. The base station 100 is also, for example, a scheduling device equipped with a scheduling device. The base station 100 and the respective terminals 200-1 and 200-2 perform wireless communication according to the scheduling result.

The base station 100 includes a base band unit (BBU) 110, a remote radio head (RRH: a wireless unit) 160, and an antenna 165. For example, the BBU 110 may be referred to as a base station. For example, the BBU 110 and the RRH 160 may be provided in positions physically separated from each other, such as about several km, and may be coupled by an optical fiber cable or the like. Note that it may be a base station in which the BBU 110 and the RRH 160 are integrated.

The base station 100 in the second embodiment may use two wireless communication methods of, for example, a wireless communication method by LTE and a wireless communication method by NB-IoT.

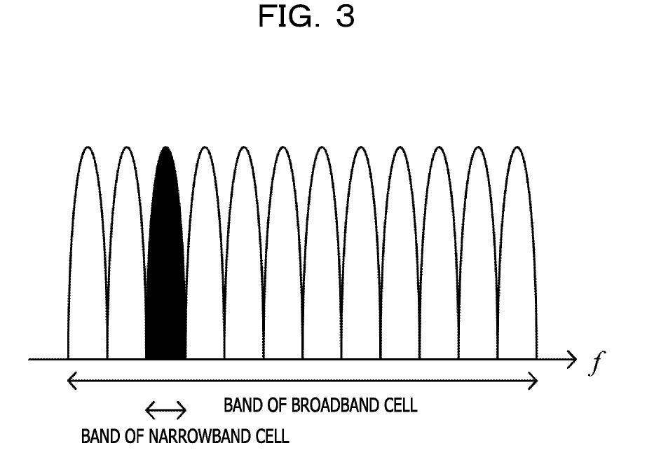

FIG. 3 illustrates an example of a frequency band used in two wireless communication methods. In the LTE wireless communication method, a frequency band of a predetermined frequency bandwidth is available. On the other hand, in the NB-IoT wireless communication method, some frequency bands included in the wireless frequency band of LTE are available. In this manner, as an NB-IoT carrier, an operation mode by “In carrier operation” is used. In the following description, for example, the frequency band available for the LTE wireless communication method is referred to as a broad band (or an LTE band), and the frequency band available for the NB-IoT wireless communication method is referred to as a narrow band (or an NB-IoT band).

Returning to FIG. 2, the base station 100 can wirelessly communicate with the broadband terminal 200-2 by using a frequency band of a broad band according to the LTE wireless communication method. Further, the base station 100 can wirelessly communicate with the narrowband terminal 200-1 by using a frequency band of a narrow band according to the NB-IoT wireless communication method.

The narrowband terminal 200-1 and the broadband terminal 200-2 are, for example, wireless terminal devices or wireless communication apparatuses such as a smartphone, a feature phone, a tablet terminal, a personal computer, and a game device. Note that the narrowband terminal 200-1 may be, for example, a device having a wireless communication function usable as IoT such as a smart meter.

The narrowband terminal 200-1 can wirelessly communicate with the base station 100 by using a frequency band of a narrow band according to, for example, the NB-IoT wireless communication method. In the NB-IoT wireless communication method, for example, the narrowband terminal 200-1 wirelessly communicates with the base station 100 at a regular cycle by using DRX. At this time, the narrowband terminal 200-1 performs wireless communication according to the preset DRX setting. The narrowband terminal 200-1 performs scheduling of radio resources to be used for wireless communication in the DRX setting. Accordingly, the narrowband terminal 200-1 may be, for example, a scheduling device equipped with a DRX scheduler.

On the other hand, the broadband terminal 200-2 performs wireless communication with the base station 100 using the LTE wireless communication method, by using the radio resources allocated by scheduling in the base station 100.

The narrowband terminal 200-1 and the broadband terminal 200-2 can also receive various services through the base station 100.

In addition, in the example of FIG. 2, an example in which a single base station 100, a single narrowband terminal 200-1, and a single broadband terminal 200-2 are disposed in the wireless communication system 10 is illustrated, but a plurality of ones may be disposed.

The respective configuration examples of the base station 100, the narrowband terminal 200-1, and the broadband terminal 200-2 will be described below.

<Configuration Example of Base Station>

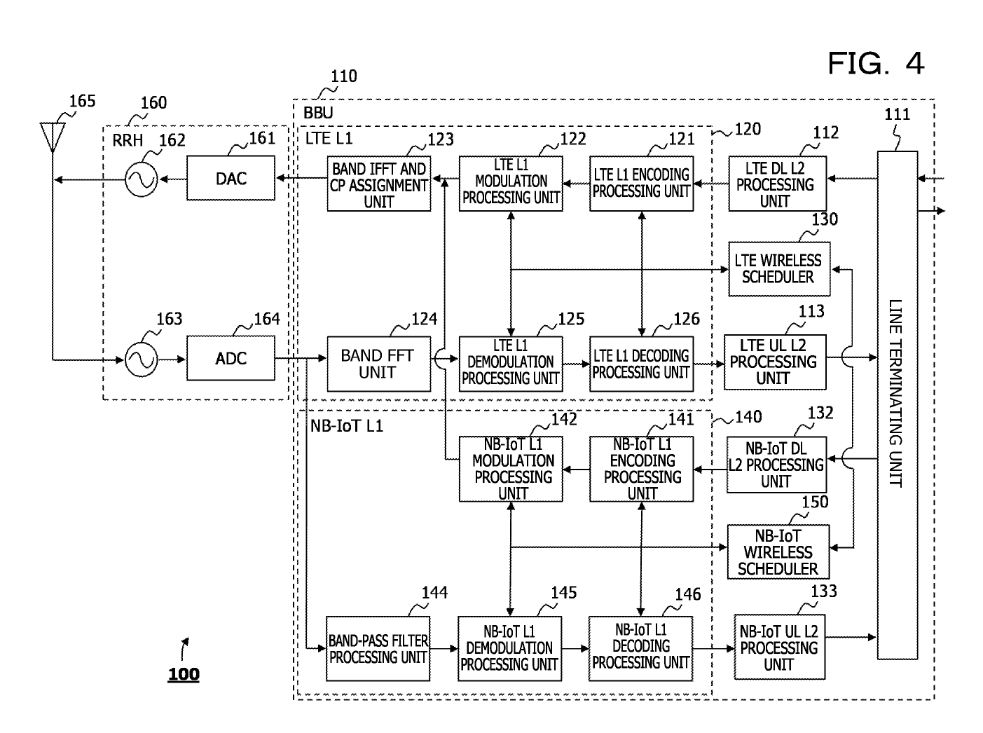

FIG. 4 is a diagram illustrating a configuration example of the base station 100. The base station 100 includes a BBU 110, an RRH 160, and an antenna 165.

The BBU 110 includes a line terminating unit 111, an LTE Downlink Layer 2 (DL L2) processing unit 112, an LTE Uplink (UL) L2 processing unit 113, an LTE Layer 1 (L1) processing unit 120, and an LTE wireless scheduler 130. In addition, the BBU 110 includes an NB-IoT DL L2 processing unit 132, an NB-IoT UL L2 processing unit 133, an NB-IoT L1 processing unit 140, and an NB-IoT wireless scheduler 150.

Further, the LTE L1 processing unit 120 includes an LTE L1 encoding processing unit 121, an LTE L1 modulation processing unit 122, a band Inverse Fast Fourier Transfer (IFFT) and Cyclic Prefix (CP) assignment unit 123, a band Fast Fourier Transfer (FFT) unit 124, an LTE L1 demodulation processing unit 125, and an LTE L1 decoding processing unit 126.

Further, the NB-IoT L1 processing unit 140 includes an NB-IoT L1 encoding processing unit 141, an NB-IoT L1 modulation processing unit 142, a band-pass filter processing unit 144, an NB-IoT L1 demodulation processing unit 145, and an NB-IoT L1 decoding processing unit 146.

Further, the RRH 160 includes a Digital to Analogue Converter (DAC) 161, a transmission transmitter 162, a reception transmitter 163, and an Analogue to Digital Converter (ADC) 164.

A first scheduler 150 in the first embodiment corresponds to, for example, an NB-IoT wireless scheduler 150. A second scheduler 130 in the first embodiment corresponds to, for example, an LTE wireless scheduler 130.

The line terminating unit 111 terminates the coupling with the core network 300. For example, the line terminating unit 111 receives packet data transmitted from the core network 300, extracts transmission data and the like from the received packet data, and outputs the extracted transmission data to the LTE DL L2 processing unit 112 or the NB-IoT DL L2 processing unit 132. In this case, the line terminating unit 111 may distribute the transmission data to the LTE DL L2 processing unit 112 or the NB-IoT DL L2 processing unit 132 based on the Tunnel Endpoint Identifier (TEID) included in the packet data.

For example, the line terminating unit 111 converts the transmission data or the like output from the LTE UL L2 processing unit 113 or the NB-IoT UL L2 processing unit 133 into packet data, and transmits the converted packet data to the core network 300.

The LTE DL L2 processing unit 112 stores, for example, the transmission data output from the line terminating unit 111 in the buffer and notifies the LTE wireless scheduler 130 of the size of the transmission data stored in the buffer. In addition, the LTE DL L2 processing unit 112 receives, for example, the scheduling information output from the LTE wireless scheduler 130, and outputs the transmission data to the LTE L1 encoding processing unit 121 according to the scheduling information. The buffer may be in, for example, the LTE L1 processing unit 120.

The LTE L1 encoding processing unit 121 performs an error correction encoding process (hereinafter, it may be referred to as a “encoding process” in some cases) on the transmission data output from the LTE DL L2 processing unit 112, according to, for example, the scheduling information output from the LTE wireless scheduler 130. The LTE L1 encoding processing unit 121 outputs the transmission data after the encoding process (hereinafter, it may be referred to as “encoded data” in some cases) to the LTE L1 modulation processing unit 122.

The LTE L1 modulation processing unit 122 performs a modulation process on the encoded data output from the LTE L1 encoding processing unit 121, according to, for example, the scheduling information output from the LTE wireless scheduler 130. The LTE L1 modulation processing unit 122 outputs, for example, the transmission data after the modulation process as a modulation signal to a band IFFT and CP assignment unit (hereinafter, it may be referred to as a “band IFFT unit” in some cases) 123.

The band IFFT unit and CP assignment unit 123 (hereinafter, it may be referred to as a “band IFFT unit” in some cases) multiplexes, for example, the modulation signal output from the LTE L1 modulation processing unit 122 and the modulation signal output from the NB-IoT L1 modulation processing unit 142 in the frequency domain, and performs an IFFT process and a CP assigning process on the modulation signal after multiplexing.

The band IFFT unit 123 outputs the modulation signal subjected to the CP assigning process and the like to the RRH 160 as a baseband signal.

The DAC 161 converts the digital baseband signal output from the band IFFT unit 123 into an analog baseband signal. The transmission transmitter 162 converts the analog baseband signal output from the DAC 161 into a wireless signal of a radio frequency band, and outputs the converted wireless signal to the antenna 165. In this case, the transmission transmitter 162 performs frequency conversion to form a wireless signal having a narrow band for the narrowband terminal 200-1 and a wireless signal having a broadband frequency for the broadband terminal 200-2.

The antenna 165 transmits the wireless signal output from the transmission transmitter 162 to the narrowband terminal 200-1 or the broadband terminal 200-2. Further, the antenna 165 receives a wireless signal transmitted from the narrowband terminal 200-1 or the broadband terminal 200-2, and output the received wireless signal to the reception transmitter 163.

The reception transmitter 163 converts the wireless signal of the frequency band into the baseband signal of the baseband band, and outputs the converted baseband signal to the ADC 164. The ADC 164 converts the analog baseband signal output from the reception transmitter 163 into a digital baseband signal. In this case, the reception transmitter 163 may receive, for example, the wireless signal transmitted from the narrowband terminal 200-1 using a frequency band of a narrow band, and may receive the wireless signal transmitted from the broadband terminal 200-2, using a frequency band of a broad band.

The band FFT unit 124 receives, for example, the baseband signal output from the ADC 164, and performs a band FFT process on the received baseband signal. For example, broadband baseband signal illustrated in FIG. 3 is generated by a band FFT process. The band FFT unit 124 outputs, for example, the broadband baseband signal to the LTE L1 demodulation processing unit 125.

The LTE L1 demodulation processing unit 125 performs a demodulation process on the broadband baseband signal output from the band FFT unit 124, according to, for example, the scheduling information received from the LTE wireless scheduler 130. The LTE L1 demodulation processing unit 125 outputs the data after demodulation (hereinafter, it may be referred to as a “demodulated data” in some cases) to the LTE L1 decoding processing unit 126.

The LTE L1 decoding processing unit 126 performs an error correction decoding process (hereinafter, it may be referred to as a “decoding process” in some cases) on the demodulated data output from the LTE L1 demodulation processing unit 125, according to, for example, the scheduling information received from the LTE wireless scheduler 130. The LTE L1 decoding processing unit 126 outputs the data after decoding (hereinafter, it may be referred to as “decoded data” in some cases) to the LTE UL L2 processing unit 113.

The LTE UL L2 processing unit 113 stores, for example, the decoded data output from the LTE L1 decoding processing unit 126 in a buffer, and transmits the decoded data as reception data, to the line terminating unit 111, when the decoded data stored in the buffer becomes transmittable. The buffer may be in, for example, the BBU 110.

The LTE wireless scheduler 130 executes scheduling in a case of performing wireless communication with the broadband terminal 200-2 using, for example, the LTE wireless communication method. For example, the LTE wireless scheduler 130 assigns radio resources (for example, time resources and frequency resources) to the broadband terminal 200-2, and determines a encoding rate, a modulation scheme, and the like in error correction encoding. The base station 100 and the broadband terminal 200-2 perform wireless communication using the radio resources allocated by scheduling, and the encoding rate, the modulation scheme, and the like determined by scheduling. Such assignment and determination may be referred to as, for example, scheduling in some cases. At that time, the LTE wireless scheduler 130 receives scheduling information including the allocation amount of the radio resources allocated to the narrowband terminal 200-1 in the NB-IoT wireless scheduler 150. The LTE wireless scheduler 130 may perform scheduling for the broadband terminal 200-2 based on the allocation amount. Details will be described in the operation example.

The NB-IoT DL L2 processing unit 132 stores, for example, the transmission data output from the line terminating unit 111 in the buffer, and notifies the NB-IoT wireless scheduler 150 of the size of the transmission data stored in the buffer. In addition, the NB-IoT DL L2 processing unit 132 receives, for example, the scheduling information output from the NB-IoT wireless scheduler 150, and outputs the transmission data to the NB-IoT L1 encoding processing unit 141 according to the scheduling information. The buffer may be in, for example, the NB-IoT L1 processing unit 140.

The NB-IoT L1 encoding processing unit 141 performs a encoding process on the transmission data output from the NB-IoT DL L2 processing unit 132, according to, for example, the scheduling information output from the NB-IoT wireless scheduler 150. The NB-IoT L1 encoding processing unit 141 outputs the encoded data to the NB-IoT L1 modulation processing unit 142.

The NB-IoT L1 modulation processing unit 142 performs a modulation process on the encoded data output from the NB-IoT L1 encoding processing unit 141, according to, for example, the scheduling information output from the NB-IoT wireless scheduler 150. The NB-IoT L1 modulation processing unit 142 outputs, for example, the transmission data after the modulation process, to the band IFFT unit 123.

The band-pass filter processing unit 144 performs a frequency conversion process, a band-pass filter process, and the like on, for example, the baseband signal output from the ADC 164. It is possible to extract, for example, a baseband signal having a frequency band of a narrow band illustrated in FIG. 3, by the band-pass filter process, or the like. For example, the band-pass filter processing unit 144 outputs the narrowband baseband signal to the NB-IoT L1 demodulation processing unit 145.

The NB-IoT L1 demodulation processing unit 145 performs a demodulation process on the narrowband baseband signal output from the band-pass filter processing unit 144 according to, for example, the scheduling information received from the NB-IoT wireless scheduler 150. The NB-IoT L1 demodulation processing unit 145 outputs the demodulated data after demodulation to the NB-IoT L1 decoding processing unit 146.

The NB-IoT L1 decoding processing unit 146 performs a decoding process on the demodulated data output from the NB-IoT L1 demodulation processing unit 145, according to, for example, the scheduling information received from the NB-IoT wireless scheduler 150. The NB-IoT L1 decoding processing unit 146 outputs the decoded data after decoding to the NB-IoT UL L2 processing unit 133.

The NB-IoT UL L2 processing unit 133 stores, for example, the decoded data output from the NB-IoT L1 decoding processing unit 146 in a buffer, and transmits the decoded data as the reception data, to the line terminating unit 111, when the decoded data stored in the buffer becomes transmittable. The buffer may be in, for example, the BBU 110.

The NB-IoT wireless scheduler 150 executes scheduling in a case of performing wireless communication with the narrowband terminal 200-1 using, for example, the NB-IoT wireless communication method. For example, the NB-IoT wireless scheduler 150 assigns radio resources to the narrowband terminal 200-1, determines the size of the data to be transmitted, or determines a encoding rate, a modulation scheme, and the like in error correction encoding. The base station 100 and the narrowband terminal 200-1 perform wireless communication using the radio resources allocated by scheduling, and the encoding rate, the modulation scheme, and the like determined by scheduling. At that time, the NB-IoT wireless scheduler 150 notifies the LTE wireless scheduler 130 of scheduling information including the allocation amount of the radio resources allocated to the narrowband terminal 200-1. In addition, the NB-IoT wireless scheduler 150 generates, for example, a control signal including scheduling information, and transmits it to the narrowband terminal 200-1. An example of scheduling of the NB-IoT radio resource will be described later.

<Configuration Example of Wireless Terminal Device>

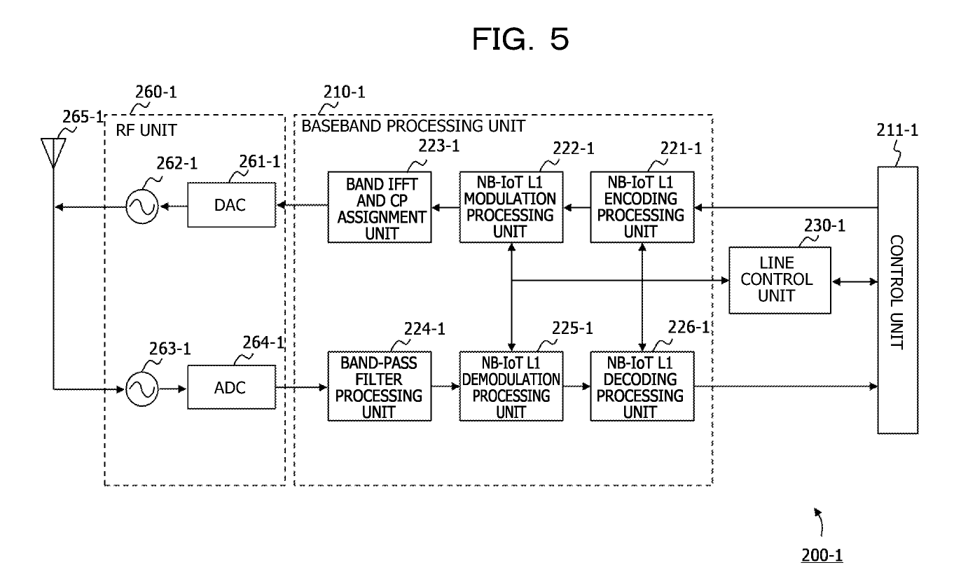

FIG. 5 is a diagram illustrating a configuration example of a narrowband terminal 200-1. The narrowband terminal 200-1 includes a control unit 211-1, a line control unit 230-1, a baseband processing unit 210-1, an RF unit 260-1, and an antenna 265-1.

The baseband processing unit 210-1 includes an NB-IoT L1 encoding processing unit 221-1, an NB-IoT L1 modulation processing unit 222-1, a band IFFT unit 223-1, a band-pass filter processing unit 224-1, an NB-IoT L1 demodulation processing unit 225-1, and an NB-IoT L1 decoding processing unit 226-1.

Further, the RF unit 260-1 includes a DAC 261-1, a transmission transmitter 262-1, a reception transmitter 263-1, and an ADC 264-1.

The control unit 211-1 is a processing block that controls the narrowband terminal 200-1. For example, the control unit 211-1 reads transmission data from a memory or the like, and outputs the transmission data to the NB-IoT L1 encoding processing unit 221-1.

The NB-IoT L1 encoding processing unit 221-1 performs a encoding process on the transmission data and the like output from the control unit 211-1, according to, for example, the scheduling information received from the line control unit 230-1.

The NB-IoT L1 modulation processing unit 222-1 performs a modulation process on the encoded data output from the NB-IoT L1 encoding processing unit 221-1, according to, for example, the scheduling information received from the line control unit 230-1.

The band IFFT unit 223-1 performs an FFT process, a CP process and the like on the modulated data output from the NB-IoT L1 modulation processing unit 222-1, and converts it into a baseband signal.

The DAC 261-1 converts the digital baseband signal output from the band IFFT unit 223-1 into an analog format digital signal. The transmission transmitter 262-1 converts the baseband signal output from the DAC 261-1 into the wireless signal of the radio frequency band, and outputs the converted wireless signal to the antenna 265-1.

The antenna 265-1 transmits the wireless signal received from the transmission transmitter 262-1, to the base station 100. Further, the antenna 265-1 receives the wireless signal transmitted from the base station 100, and outputs the received wireless signal to the reception transmitter 263-1.

The reception transmitter 263-1 converts the wireless signal to the baseband signal of the baseband band. The ADC 264-1 converts the analog baseband signal output from the reception transmitter 263-1 into a digital baseband signal.

The band-pass filter processing unit 224-1 performs a band FFT process on the baseband signal output from the ADC 264-1, and extracts, for example, a narrowband baseband signal.

The NB-IoT L1 demodulation processing unit 225-1 performs a demodulation process on the baseband signal output from the band-pass filter processing unit 224-1, according to, for example, the scheduling information received from the line control unit 230-1.

The NB-IoT L1 decoding processing unit 226-1 performs a encoding process on the demodulated data output from the NB-IoT L1 demodulation processing unit 225-1, according to, for example, the scheduling information received from the line control unit 230-1, and extracts data. The NB-IoT L1 decoding processing unit 226-1 outputs the extracted data to the control unit 211-1.

The line control unit 230-1 receives, for example, the control signal transmitted from the base station 100, from the NB-IoT L1 decoding processing unit 226-1, and extracts the scheduling information from the received control signal. The line control unit 230-1 controls the respective units based on the scheduling information.

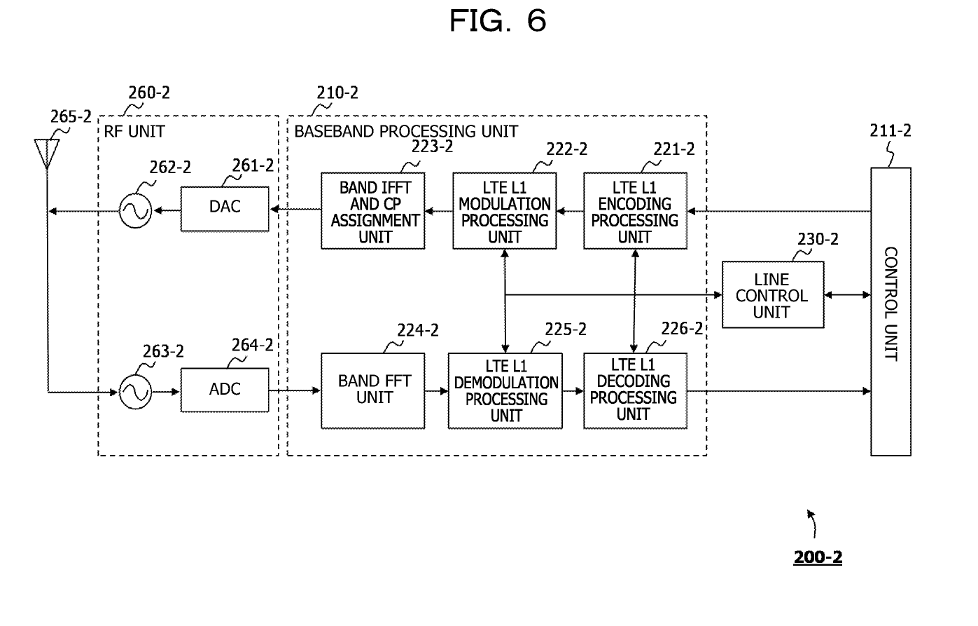

FIG. 6 is a diagram illustrating a configuration example of the broadband terminal 200-2. The broadband terminal 200-2 includes a control unit 211-2, a line control unit 230-2, a baseband processing unit 210-2, an RF unit 260-2, and an antenna 265-2.

Functions and processes executed by the LTE L1 encoding processing unit 221-2, the LTE L1 modulation processing unit 222-2, and the band IFFT unit 223-2 are the same as in, for example, the LTE L1 encoding processing unit 121, the LTE L1 modulation processing unit 122, and the band IFFT unit 123 in the base station 100, respectively.

Processes and functions executed by the band FFT unit 224-2, the LTE L1 demodulation processing unit 225-2, and the LTE L1 decoding processing unit 226-2 are the same as in, for example, the band FFT unit 124, the LTE L1 demodulation processing unit 125, and the LTE L1 decoding processing unit 126 in the base station 100, respectively.

Each processing block in the baseband processing unit 210-2 also performs each process according to the scheduling information by the line control unit 230-2.

Further, the processes and functions in each block included in the RF unit 260-1 are similar to those of the RRH 160 of the base station 100. In this case, the RF unit 260-2 in the broadband terminal 200-2 performs a process on a broadband wireless signal and the like.

<Scheduling Example of Radio Resource in NB-IoT Wireless Communication Method>

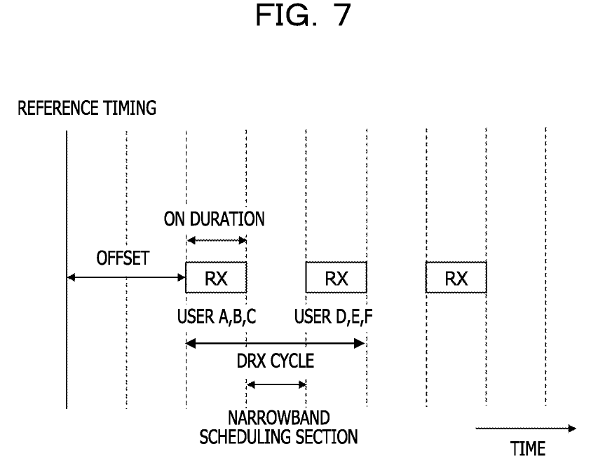

Next, scheduling examples of radio resources in the NB-IoT wireless communication method will be described. FIG. 7 illustrates an example of the scheduling example, particularly, an example of the timing of using time resources.

As illustrated in FIG. 7, for example, continuous timing sections at a regular cycle are allocated as NB-IoT radio resources.

A continuous timing section that a certain user (or the narrowband terminal 200-1, hereinafter, it may be referred to as a “user” in some cases) can receive may be referred to as Discontinuous Reception (DRX) on duration, or on duration in some cases. Further, the length of DRX on duration may be referred to as, for example, DRX on duration length or on duration length.

DRX on duration is started, for example, after the offset amount has elapsed from the (absolute) reference timing. The offset amount may be referred to as, for example, a DRX cycle offset in some cases.

DRX on duration can be set at a regular cycle. The regular cycle may be referred to as, for example, a DRX cycle.

For example, the DRX cycle, the DRX cycle offset, and the DRX on duration (length thereof) can be set for each user. In the example of FIG. 7, the DRC cycle, the DRX cycle offset, and the DRX on duration are common to the users A, B, and C, and are also common to the users D, E, and F. The users A, B, and C and the users D, E, and F have different DRX cycle offsets, and the others are common in the users.

The DRX limits in advance the timing of receiving the wireless signal in the down direction by the user, thereby suppressing the power consumption associated with the reception process by the user. DRX may be referred to as for example, intermittent transmission or intermittent reception in some cases.

For example, in the base station 100, the NB-IoT DL L2 processing unit 132 may read and output the data stored in the buffer such that the data can be received at the timing of DRX on duration for each user.

Note that the time section obtained by dividing the DRX cycle with the DRX on duration length may be referred to as, for example, a narrowband scheduling section in some cases.

### Operation Example

Next, an operation example in the base station 100 will be described. In the operation example, there is, for example, a process of calculating the allocation amount of the radio resources allocated to the narrowband terminal 200-1 in the NB-IoT wireless scheduler 150. As an operation example, there is, for example, a process of allocating radio resources to the broadband terminal 200-2 in the LTE wireless scheduler 130 based on the calculated amount of allocation. There is also a reception process at the narrowband terminal 200-1 according to the allocation. The processes will be described in order below.

<1. Radio Resource Allocation Amount Calculation Process in NB-IoT Wireless Communication Method>

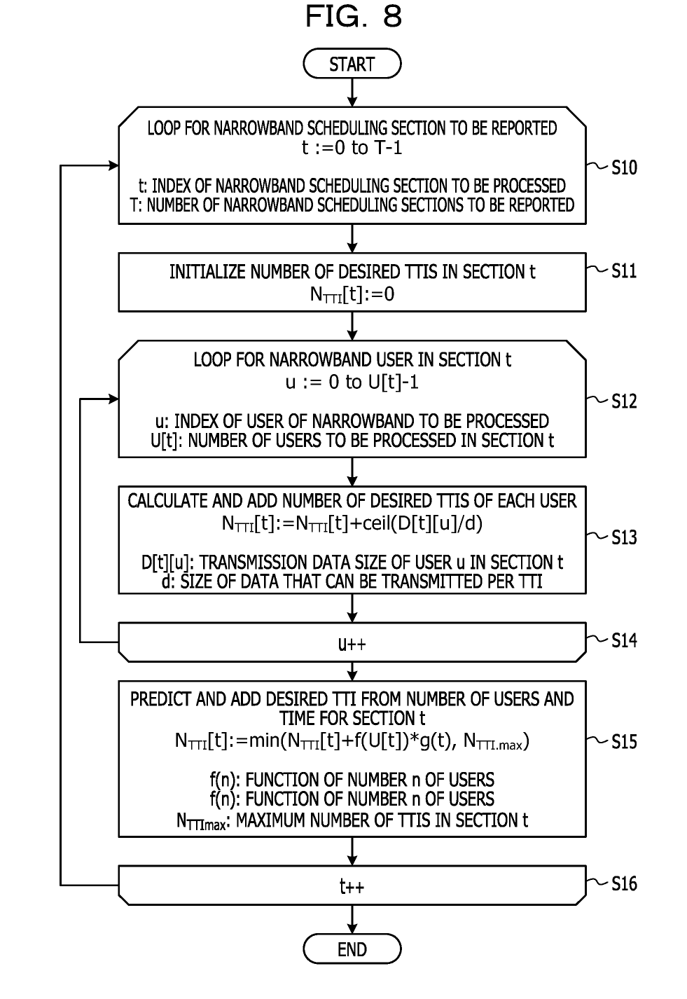

FIG. 8 is a flowchart illustrating an example of a process of calculating the allocation amount of the radio resource in the NB-IoT wireless communication method. Such a calculation process is performed by, for example, the NB-IoT wireless scheduler 150. Here, as the allocation amount, for example, the number of transmission time intervals (TTI) will be described as an example. TTI is, for example, a transmission time interval (or transmission time unit) of data or the like, which is 1 msec (=1 subframe) in LTE.

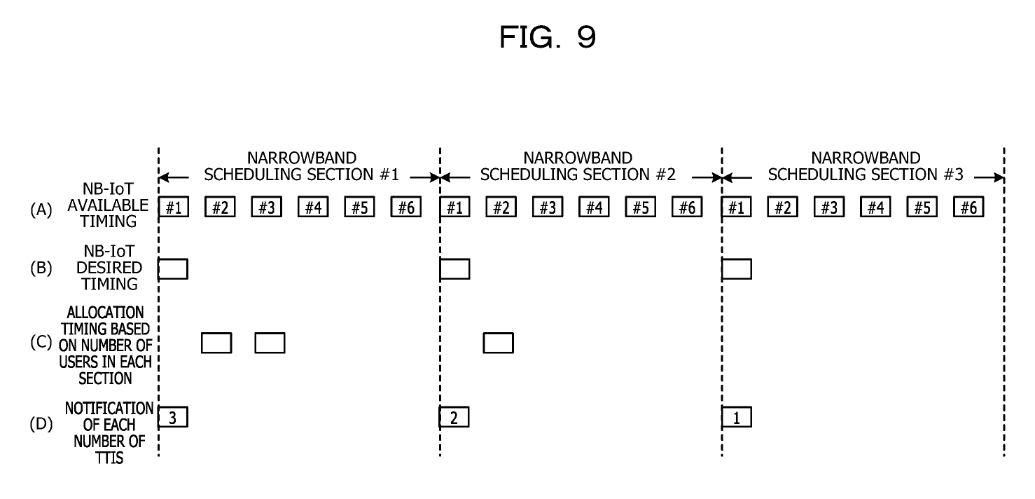

FIG. 9 illustrates examples of scheduling. Among the examples, (A) in FIG. 9 illustrates an example of the timing when NB-IoT is available.

The NB-IoT available timing is represented by a square frame in (A) in FIG. 9, and for example, one frame represents one TTI. The available TTI in NB-IoT may be, for example, an integer multiple of TTI in LTE. One TTI in NB-IoT may be, for example, 1 msec or a time interval shorter than 1 msec. Even in FIGS. 9B to 9D, for example, one frame represents one TTI.

As illustrated in (A) in FIG. 9, the TTI of the NB-IoT may be a discontinuous section or a continuous section in the narrowband scheduling section. Further, the TTI may be the entire narrowband scheduling section, or may be a part of the section.

In the calculation process illustrated in FIG. 8, for example, the number of TTIs for transmitting all data from the base station 100 to all users under the base station 100 in the narrowband scheduling section is calculated. The number of TTIs calculated in FIG. 8 may be referred to as, for example, the number of desired TTIs, in some cases. The number of desired TTIs can be calculated by, for example, the following expression.

N_{TTI}^{req}[t]=Σ_{uεU[t]}┌Dᵤ/d_{TTI}^{max}┐ (1)

Here, if the left expression of Expression (1) is described as N_{TTI}[t], N_{TTI}[t] represents the number of desired TTIs in the narrowband scheduling section t. Further, u represents the user identification (ID: identification information), and Dᵤ represents the transmission data size of the user u. Furthermore, if the denominator of the right expression in Expression (1) is described as d_{TTI}, d_{TTI} represents the maximum size of data that can be transmitted per TTI. In Expression (1), for example, the number of TTI (or time) for transmitting all the data addressed to the narrowband terminal 200-1 to all the narrowband terminals 200-1 under the base station 100 that performs wireless communication in the narrowband scheduling section tin the NB-IoT wireless communication method is calculated.

The flowchart illustrated in FIG. 8 eventually represents, for example, a process for calculating the number of desired TTIs N_{TTI}[t] in Expression (1).

When calculating the number of desired TTIs illustrated in Expression (1), the following is assumed. For example, the DRX cycle and the DRX on duration are common to all users. Further, the DRX cycle offset that can be set for each user is an integer multiple of DRX on duration. Further, when performing wireless communication with the narrowband terminal 200-1, the base station 100 can transmit data to one user per TTI. With this assumption, for example, the base station 100 can allocate one narrowband scheduling section to each user.

As illustrated in FIG. 8, upon starting the process (S10), the NB-IoT wireless scheduler 150 executes a loop for the narrowband scheduling section to be reported (S11). for example, the NB-IoT wireless scheduler 150 repeats the following from “0” to “T−1”, the index t of the narrowband scheduling section. Here, T represents, for example, the number of narrowband scheduling sections.

Next, the NB-IoT wireless scheduler 150 initializes the number of desired TTIs in the narrowband scheduling section t (S12).

Next, the NB-IoT wireless scheduler 150 executes a loop corresponding to the number of users, for the narrowband user (or the narrowband terminal 200-1) in the narrowband scheduling section t (S13). For example, the NB-IoT wireless scheduler 150 repeats the following process from “0” to “U(t)−1” for the user u. Here, U(t) represents, for example, the number of users to be processed in the narrowband scheduling section t, or the number of users performing wireless communication by the NB-IoT with the base station 100 in the section t.

Next, the base station 100 calculates the number of desired TTIs of each user using the following expression (S14).

N_{TTI}[t]=N_{TTI}[t]+ceil(D[t][u]/d) (2)

In Expression (2), N_{TTI}[t] represents the number of desired TTIs, D[t][u] represents the transmission data size of the user u in the narrowband scheduling section t, and d represents the size of data that can be transmitted per TTI, respectively. In addition, Ceil is a function that can be used in, for example, C language, or the like, and is a function of obtaining a result by raising the value specified in the argument. Equations (1) and (2) illustrate the same contents, and it is possible to perform calculation using Expression (2) for realizing Expression (1) concretely.

Specifically, for Expression (2) (or Expression (1)), attention is paid to a certain user u in the narrowband scheduling section t. The number of TTIs for transmitting the transmission data addressed to the user u is calculated by dividing the size of the transmission data addressed to the user u by the size of data that can be transmitted in one TTI.

For example, the NB-IoT wireless scheduler 150 calculates the number of desired TTIs for each user, by reading Expression (1) or Expression (2) stored in a memory or the like, and inserting values thereto.

Then, the NB-IoT wireless scheduler 150 adds 1 to the user u, repeats the above-described process for the next user, and further performs the process of S14 for all users in the narrowband scheduling section t (S15). For example, the NB-IoT wireless scheduler 150 calculates the number of desired TTIs for all the users within the narrowband scheduling section t, thereby calculating the number of TTIs for transmitting all the data to all the users in the narrowband scheduling section t.

The NB-IoT wireless scheduler 150 calculates the number of TTIs taking into consideration of the prediction of data generation, when calculating the number of desired TTIs for all the users within the narrowband scheduling section t (S16).

For example, the NB-IoT wireless scheduler 150 regards transmission data addressed to the narrowband terminal 200-1 received from the core network 300 and stored in the buffer, as a scheduling target. When the cycle of the determination process of the NB-IoT radio resource is sufficiently long, a difference between the timing when the radio resource is determined and the timing when the radio resource is allocated is equal to or larger than a first threshold, and a likelihood of further receiving the transmission data from the core network 300 is higher than a second threshold. Therefore, for example, the NB-IoT wireless scheduler 150 predicts the generation of data in advance to some extent and adds the predicted prediction value to the number of desired TTIs when calculating the number of desired TTIs. The NB-IoT wireless scheduler 150 calculates the number of desired TTIs for which data generation is predicted, using, for example, the following expression.

N_{TTI}^{req}[t]=N_{TTI}^{req}[t]+ƒ(∥U(t)∥)g(τ(t)) (3)

In Expression (3), ∥U∥ is the number of elements of the set U, f(n) is a function of the number of users nεN, τ(t) is the time from the current time to the narrowband scheduling section t, and g(τ) represents a function of time τ, respectively.

As the function f(n) of the number n of users and the function g(τ) of the time τ, for example, functions which are positive for arguments n and τ and both monotonically increase are selected. The reason is that for example, the larger the number of users and the longer the time from the current time to the narrowband scheduling section t, the more the possibility that the base station 100 receives transmission data from the core network 300.

In FIG. 8, the following expression is used instead of Expression (3).

N_{TTI}[t]=min(N_{TTI}[t]+ƒ(U[t])*g(t),N_{TTI,max}) (4)

In Expression (4), N_{TTI}[t] represents the number of desired TTIs for which the generation of data is predicted, N_{TTI.max} represents the maximum number of TTI of the narrowband scheduling section t, respectively. In Expression (4), the number of desired TTIs in the narrowband scheduling section t is calculated such that the number of desired TTIs for which the generation of data is predicted is equal to or less than the maximum number of TTIs.

Next, the base station 100 increments the narrowband scheduling section t, and repeats the above-described process for the narrowband scheduling section (t+1) of the next section (S17).

If the base station 100 repeats the above-described process from “0” to “T−1” for the narrowband scheduling section t (loop from S11 to S17), and ends the series of processes (S18).

(D) in FIG. 9 illustrates an example of the notification timing of the number of desired TTIs calculated by the NB-IoT wireless scheduler 150.

In the example of (D) in FIG. 9, an example in which the NB-IoT wireless scheduler 150 calculates “3” as the number of TTIs in the narrowband scheduling section #1. In this case, also in the NB-IoT wireless communication method, there are signals transmitted and received before and after data transmission, such as for example, a synchronization signal, broadcast information, and a random access channel (RACH) response. Transmission and reception of such signals are performed, for example, at timings determined in advance. The NB-IoT wireless scheduler 150 automatically counts the timings determined in advance as the number of TTIs, for example. The “NB-IoT mandatory timing” in (B) in FIG. 9 is an example of the timing determined in advance as described above. The NB-IoT wireless scheduler 150 may calculate the number of desired TTIs including this timing (for example, S14 in FIG. 8).

Therefore, in a case where the number of TTIs is “3” in the example of (D) in FIG. 9, in the narrowband scheduling section #1, “2” is allocated as the number of TTIs used for data transmission by the user (hereinafter, it may be referred to as “the number of used TTIs” in some cases).

In this case, as illustrated in FIGS. 9B and 9C, TTI #2 and TTI #3 are allocation timings for users. For example, any TTI such as TTI #5 and TTI #6, or TTI #3 and TTI #5 may be used as the allocation timing.

As illustrated in (D) in FIG. 9, in the next narrowband scheduling section #2, the number of TTIs is “2”, the number of used TTIs is “1”, and TTI #2 is an allocation timing. Further, in the narrowband scheduling section #3, the number of desired TTIs is “1” and the number of used TTIs is “0”.

Note that the NB-IoT wireless scheduler 150 may notify, for example, the LTE wireless scheduler 130 and the narrowband terminal 200-1 of the number of desired TTIs, or may notify only one thereof. Alternatively, the NB-IoT wireless scheduler 150 may notify, for example, the LTE wireless scheduler 130 and the narrowband terminal 200-1 of the number of used TTIs, or may notify only one thereof.

<2. Radio Resource Allocation Process for Broadband Terminal>

Next, the radio resource allocation process for the broadband terminal 200-2 by the LTE wireless scheduler 130 will be described.

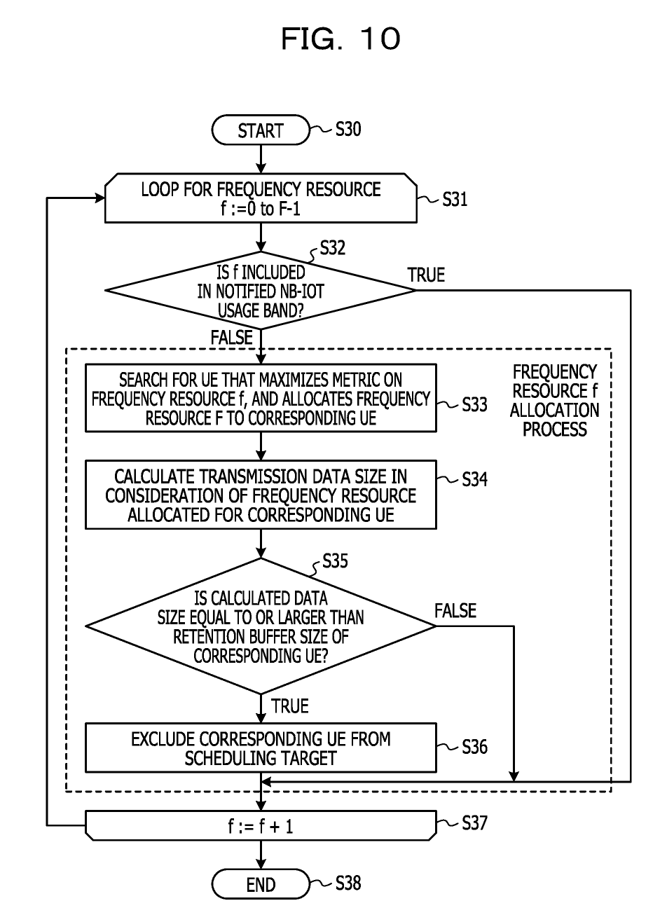

FIG. 10 is a flowchart illustrating an example of the allocation process. As described above, the LTE wireless scheduler 130 is notified of, for example, the number of desired TTIs as the allocation amount of the NB-IoT radio resource. The LTE wireless scheduler 130 allocates LTE radio resources by avoiding the radio resources allocated for NB-IoT, based on, for example, the number of desired TTIs. FIG. 10 illustrates such a radio resource allocation example. The process illustrated in FIG. 10 is performed by, for example, the LTE wireless scheduler 130.

Upon starting the process (S30), the LTE wireless scheduler 130 repeats the following process from “0” to “F−1” for the frequency resource f (S31).

Next, the LTE wireless scheduler 130 determines whether or not the frequency resource f is included in the notified NB-IoT usage band (S32). For example, the LTE wireless scheduler 130 receives the notification of the number of desired TTIs, recognizes that the NB-IoT narrow band (for example, FIG. 3) is used, and allocates the broadband radio resource to the broadband terminal 200-2 by avoiding the narrowband. On the other hand, for example, the LTE wireless scheduler 130 recognizes that wireless communication by the NB-IoT is not performed when not receiving the notification of the number of desired TTIs, and allocates the radio resource of the frequency band including the NB-IoT narrowband to the broadband terminal 200-2.

That is, as illustrated in FIG. 10, when receiving the notification of the number of desired TTIs for the frequency resource f (True in S32), the LTE wireless scheduler 130 increments the frequency resource f without allocating the frequency resource f to the broadband terminal 200-2 (S37).

On the other hand, when the notification of the number of desired TTIs for the frequency resource f is not received, the LTE wireless scheduler 130 executes a process of allocating the frequency resource f to the broadband terminal 200-2 (S33 to S36).

Specifically, the LTE wireless scheduler 130 searches for the broadband terminal 200-2 that maximizes the metric on the frequency resource f, and allocates the frequency resource f to the corresponding broadband terminal 200-2 (S33). Next, the LTE wireless scheduler 130 calculates the transmission data size in consideration of the allocated frequency resource f, for the corresponding broadband terminal 200-2 (S34). Then, the LTE wireless scheduler 130 determines whether or not the calculated data size is equal to or larger than the retention buffer size for storing the transmission data to be transmitted to the corresponding broadband terminal 200-2 (S35). When the data size is equal to or larger than the retention buffer size (True in S35), the LTE wireless scheduler 130 excludes the corresponding broadband terminal 200-2 from scheduling targets (S36). The process proceeds to S37. On the other hand, when the data size is smaller than the retention buffer size (False in S35), the LTE wireless scheduler 130 maintains the allocation to the corresponding broadband terminal 200-2, and proceeds to S37.

When the above-described process is performed on all the target frequency resources f (the loop from S31 to S37), the LTE wireless scheduler 130 ends the series of processes (S38).

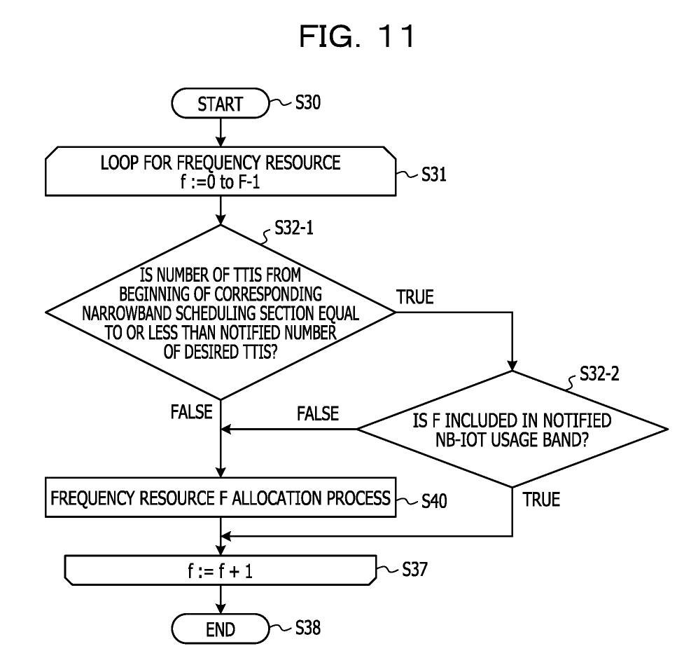

In the example described above, for example, an example in which the LTE wireless scheduler 130 allocates a radio resource with or without notification of the number of desired TTIs has been described. For example, the LTE wireless scheduler 130 may allocate radio resources by using the numerical value of the number of desired TTIs. FIG. 11 is a flowchart illustrating an example of radio resource allocation to the broadband terminal 200-2 in such a case.

In the example of FIG. 11, the LTE wireless scheduler 130 determines whether or not the number of TTIs from the beginning of the narrowband scheduling section is equal to or less than the notified number of desired TTIs (S32-1). For example, when the number of TTIs included in the narrowband scheduling section is larger than the number of desired TTIs, the NB-IoT wireless scheduler 150 may not allocate the radio resource based on the number of desired TTIs.

Therefore, when the number of TTIs from the beginning of the corresponding narrowband scheduling section is larger than the number of desired TTIs (False in S32-1), the LTE wireless scheduler 130 sets the frequency band including the narrowband to the broadband terminal 200-2 (S40).

On the other hand, when the number of TTIs from the beginning of the corresponding narrowband scheduling section is equal to or less than the number of desired TTIs (True in S32-1), the LTE wireless scheduler 130 determines whether or not the frequency resource f is included in the NB-IoT usage band based on the number of desired TTIs (S32-2).

Similarly to the above example, when the frequency resource f is included in the NB-IoT usage band (True in S32-2), the LTE wireless scheduler 130 does not allocate the frequency resource f as a NB-IoT narrowband to the broadband terminal 200-2, and proceeds to S37. On the other hand, when the frequency resource f is not included in the NB-IoT usage band (False in S32-2), the LTE wireless scheduler 130 performs a process of allocating the frequency resource f to the broadband terminal 200-2 (S40). Note that S40 corresponds to the process from S33 to S36 of FIG. 10.

As described above, the LTE wireless scheduler 130 can allocate the radio resource by avoiding the NB-IoT narrowband when receiving the notification of the number of desired TTIs, or allocate the frequency resources including a narrow band when not receiving the notification of the number of desired TTIs. Therefore, the LTE wireless scheduler 130 can dynamically adjust the radio resource based on the number of desired TTIs. Therefore, the LTE wireless scheduler 130 can perform an efficient operation for the LTE wireless communication.

<3. Reception Operation of Narrowband Terminal>

Next, an operation example by the narrowband terminal 200-1 in a case where the number of desired TTIs is received will be described.

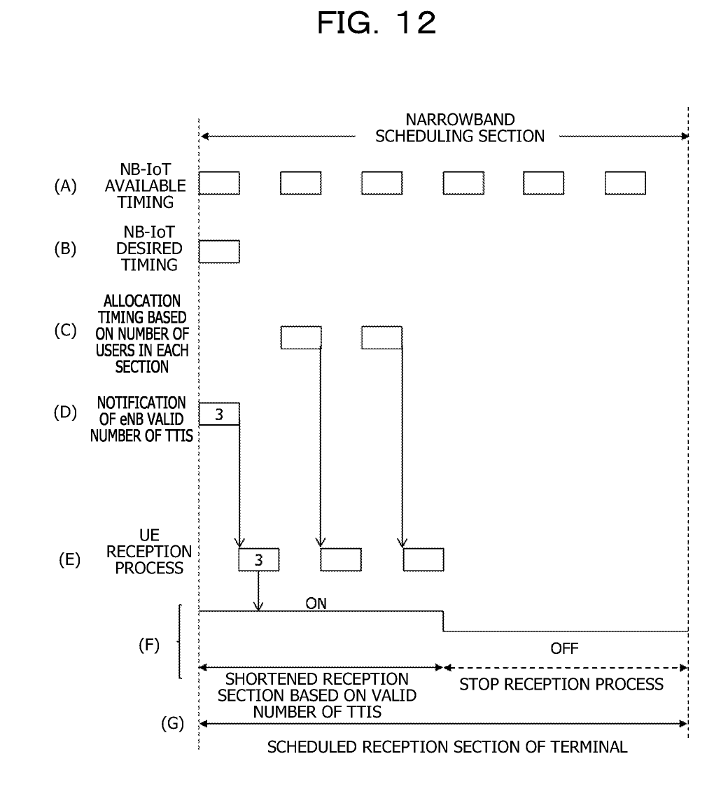

FIGS. 12A to 12G are flowcharts illustrating operation examples. Also in FIGS. 12A to 12G, for example, one frame represents one TTI. As illustrated in FIGS. 12A to 12D, an example is illustrated in which “3” is notified as the number of desired TTIs.

The process until the number of desired TTIs is notified from the base station 100 to the narrowband terminal 200-1 is, for example, as follows. That is, the NB-IoT wireless scheduler 150 of the base station 100 generates a control signal including the number of desired TTIs, and outputs the generated control signal to the NB-IoT L1 encoding processing unit 141. The control signal is subjected to an encoding process by the NB-IoT L1 encoding processing unit 141 and a modulation process by the NB-IoT L1 modulation processing unit 142, converted into a wireless signal, and transmitted to the narrowband terminal 200-1. The number of desired TTIs is transmitted, for example, at the beginning timing of the narrowband scheduling section. The narrowband terminal 200-1 converts the wireless signal into a baseband signal by frequency conversion or the like, performs a demodulation process in the NB-IoT L1 demodulation processing unit 225-1, performs a decoding process in the NB-IoT L1 decoding processing unit 226-1, and extracts a control signal. The extracted control signal is output to the line control unit 230-1. The line control unit 230-1 can monitor the downstream signal at the DRX on duration according to the preset DRX setting, try to receive the control signal at the beginning TTI that becomes the DRX on duration, and extract the number of desired TTIs from the received control signal.

As illustrated in FIG. 12, the narrowband terminal 200-1 performs a reception process at the timing allocated to the narrowband terminal 200-1, out of the timings of the DRX on duration, based on the number of desired TTIs (for example, ON in (F) in FIG. 12). Then, the narrowband terminal 200-1 stops the reception process for the timing not allocated (for example, OFF in (F) in FIG. 12).

Thus, for example, since the narrowband terminal 200-1 does not have to perform a reception process for all of the timings of the DRX on duration, it is possible to reduce the power consumption as compared with the case where the reception process is performed for all of the timings. Therefore, in the wireless communication system 10, it is also possible to dynamically adjust the reception processing timing and adjust the power for the narrowband terminal 200-1. Therefore, it is possible to efficiently operate the wireless communication system 10 as a whole.

### Third Embodiment

In the second embodiment described above, in the calculation of the number of desired TTIs (for example, S14 in FIG. 8), a description is made assuming that 1 TTI=1 user. For example, it may be established that 1 TTI=a plurality of users. The calculation formula of the number of desired TTIs in this case is, for example, as follows.

$${N}_{TTI}^{req} [ t ] = {\sum }_{u ∈ U [ t ]}^{ } ⌊ {D}_{u} / {d}_{TTI}^{ma x} ⌋ + ( {\sum }_{u ∈ U [ t ]}^{ } max ( {D}_{u} mod {d}_{TTI}^{ma x} , {d}_{TTI}^{m i n} ) ) / {d}_{TTI}^{ma x} \qquad ( 5 )$$

In a case where there is no particular restriction on the multiplexing of users within the TTI, estimation of the number of desired TTIs becomes possible by the above Expression (5). In Expression (5),

d_{TTI}^{min} (6)

represents the minimum number of bits per TTI in a case of transmission from the base station 100. Since the base station 100 may not transmit the data equal to or less than the number of bits indicated by Expression (6) to the user, the data is filled with the number of bits indicated by Expression (6) by padding or the like and transmitted.

For example, similar to Expression (1) or Expression (2), Expression (5) is stored in the memory in the base station 100, and the NB-IoT wireless scheduler 150 may calculate the number of desired TTIs by reading and calculating the expression appropriately during the process.

### Fourth Embodiment

In the second embodiment described above, an example (for example, S16 in FIG. 8) in which the number of desired TTIs is calculated by predicting data generation has been described. In this case, the first expressions on the left side and the right side of Expression (3) are integers, so it is conceivable that the second expression in Expression (2) is also an integer. The calculation formula for the number of desired TTIs in the case of integerizing the functions f( ) and g( ) is, for example, as follows.

N_{TTI}^{req}[t]=N_{TTI}^{req}[t]+┌ƒ(∥U(t)∥)g(τ(t))┐ (7)

Expression (7) is also stored in the memory in the base station 100, and the NB-IoT wireless scheduler 150 may calculate the number of desired TTIs by reading and calculating the expression appropriately during the process.

### Fifth Embodiment

In the second embodiment, an example has been described in which one base station 100 includes two schemes, an LTE wireless communication method and an NB-IoT wireless communication method (for example, FIG. 4). For example, a base station performing the LTE wireless communication method and a base station performing the NB-IoT wireless communication method may be separate base stations.

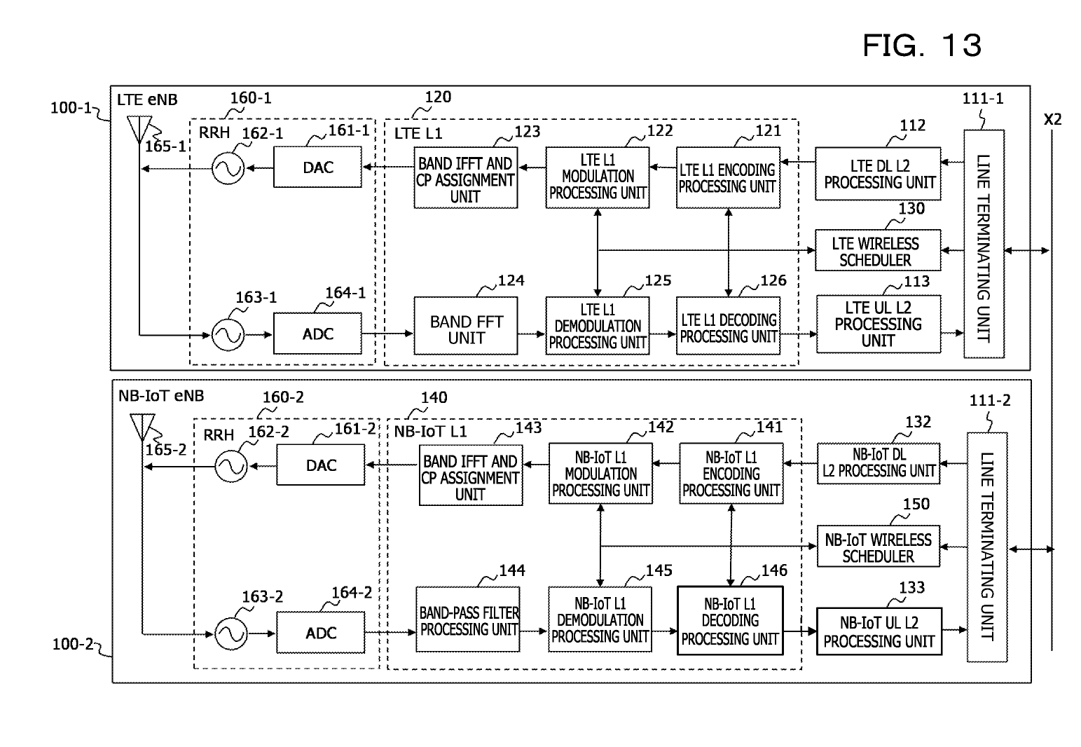

FIG. 13 is a diagram illustrating configuration examples of two base stations 100-1 and 100-2 in such a case. The base station 100-1 is a base station that performs an LTE wireless communication method and the base station 100-2 is a base station that performs an NB-IoT wireless communication method. The two base stations 100-1 and 100-2 are coupled by, for example, an X2 interface or the like, and can exchange information or the like. Therefore, the number of desired TTIs calculated by the NB-IoT wireless scheduler 150 can be transmitted from the line terminating unit 111-2 to the LTE wireless scheduler 130 through the X2 interface and the line terminating unit 111-1.

In the example of FIG. 13, the base station 100-2 further includes a band IFFT unit 143. The band IFFT unit 143 performs a band IFFT process and a CP assignment process on the modulation signal output from the NB-IoT L1 modulation processing unit 142 to convert the modulation signal to a baseband signal, and outputs the converted baseband signal to the DAC 161-2.

Since the two base stations 100-1 and 100-2 perform the scheduling in the LTE wireless scheduler 130 and the NB-IoT wireless scheduler 150, any one of the base stations 100-1 and 100-2 functions as a scheduling device.

For example, the base station 100-1 corresponds to the scheduling device 400 or the first scheduling device 410 in the first embodiment. Further, the base station 100-2 corresponds to, for example, the communication apparatus 100 in the first embodiment. Further, the NB-IoT wireless scheduler 150 corresponds to, for example, the scheduler 150 in the first embodiment. In addition, the narrowband terminal 200-1 illustrated in FIG. 2 corresponds to, for example, the scheduling device 400 or the second scheduling device 420 in the first embodiment.

### Other Embodiments

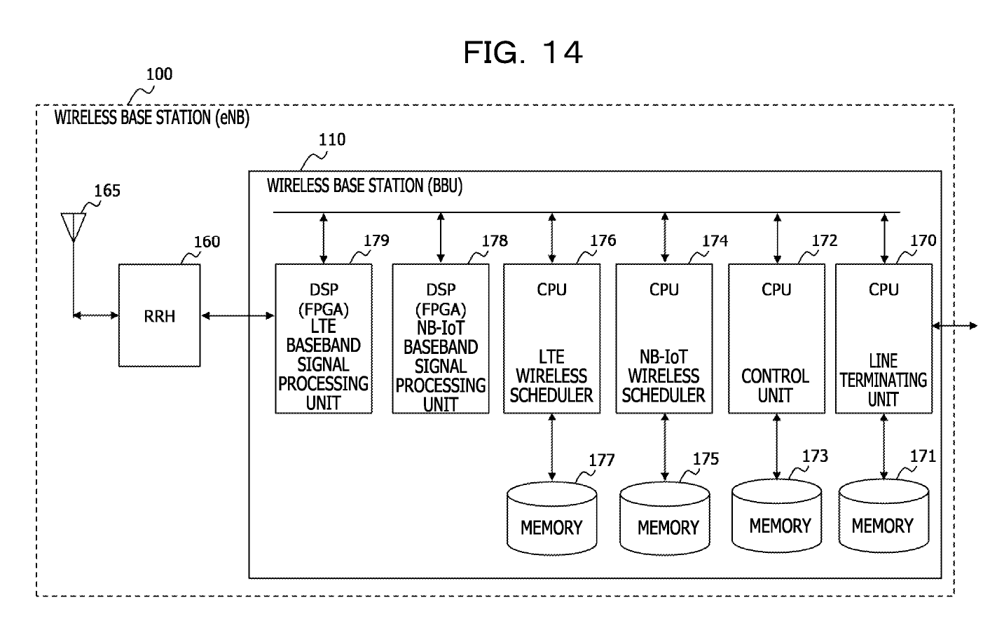

Next, other embodiments will be described. FIG. 14 is a diagram illustrating a hardware configuration example of the base station 100. The BBU 110 includes four central processing units (CPUs) 170, 172, 174, and 176, four memories 171, 173, 175, and 177, and two digital signal processors (DSP) 178 and 179.

The CPUs 170, 172, 174, and 176 respectively read and execute, for example, the programs stored in the memories 171, 173, and 175, thereby executing the functions of the line terminating unit 111, the LTE DL L2 processing unit 112, and the LTE UL L2 processing unit 113, described in the second embodiment. The CPUs 170, 172, 174, and 176 execute, for example, such a program, thereby executing the functions of the NB-IoT DL L2 processing unit 132, the NB-IoT UL L2 processing unit 133, the LTE wireless scheduler 130, and the NB-IoT wireless scheduler 150, described in the second embodiment. The CPU 170 corresponds to, for example, the line terminating unit 111. Further, the CPU 172 corresponds to, for example, the LTE DL L2 processing unit 112, the LTE UL L2 processing unit 113, the NB-IoT DL L2 processing unit 132, and the NB-IoT UL L2 processing unit 133. Further, the CPU 174 corresponds to, for example, the NB-IoT wireless scheduler 150. Further, the CPU 176 corresponds to, for example, the LTE wireless scheduler 130.

In addition, the DSP 178 can execute, for example, the process or function as the NB-IoT baseband processing unit under the control of the CPU 172. The DSP 178 corresponds to, for example, the NB-IoT L1 processing unit 140 in the second embodiment.

Furthermore, the DSP 179 can execute, for example, the process or function as the LTE baseband processing unit under the control of the CPU 172. The DSP 179 corresponds to, for example, the LTE L1 processing unit 120 in the second embodiment.

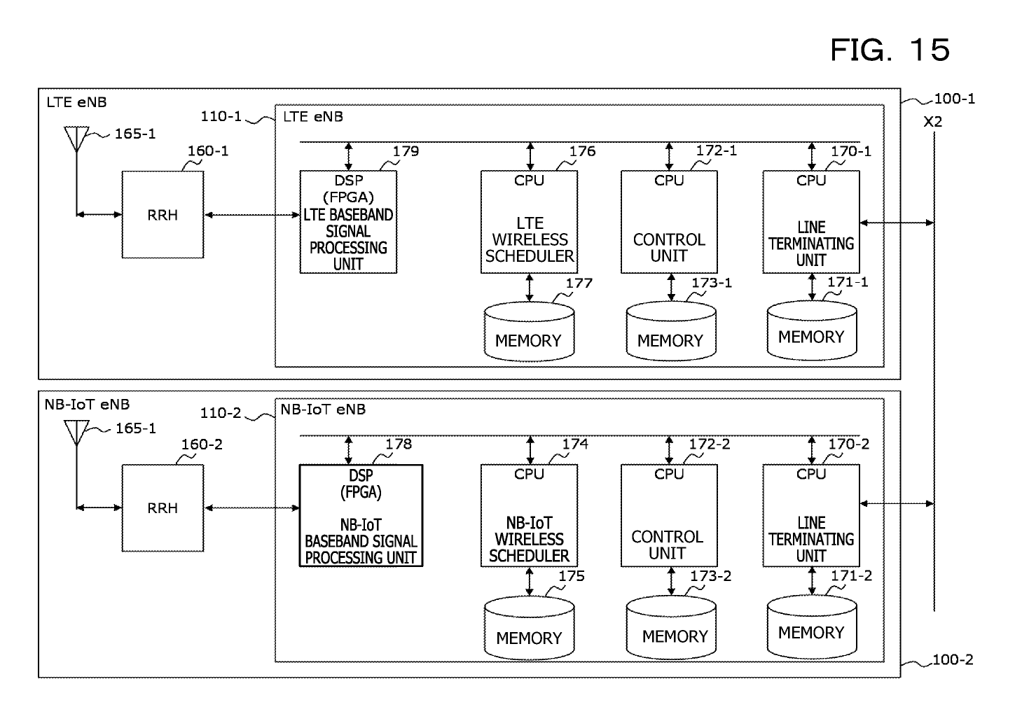

FIG. 15 illustrates a hardware configuration example in a case where the base station 100-1 of the LTE wireless communication method and the base station 100-2 of the NB-IoT wireless communication method are separate base stations.

In the base station 100-1, the CPUs 170-1, 172-1, and 176 respectively read and execute, for example, the programs stored in the memories 171-1, 173-1, and 177, thereby executing the functions of the line terminating unit 111-1, the LTE DL L2 processing unit 112, and the LTE UL L2 processing unit 113, described in the fifth embodiment. The CPU 170-1 corresponds to, for example, the line terminating unit 111-1. The CPU 172-1 corresponds to, for example, the LTE DL L2 processing unit 112 and the LTE UL L2 processing unit 113. The CPU 176 corresponds to, for example, the LTE wireless scheduler 130. Further, the DSP 179 corresponds to, for example, the LTE L1 processing unit 120.

In the base station 100-2, the CPUs 170-2, 172-2, and 174 respectively read and execute, for example, the programs stored in the memories 171-2, 173-2, and 175, thereby executing the functions of the line terminating unit 111-2, the NB-IoT DL L2 processing unit 132, the NB-IoT UL L2 processing unit 133, and the NB-IoT wireless scheduler 150, described in the fifth embodiment. The CPU 170-2 corresponds to, for example, the line terminating unit 111-2. The CPU 172-2 corresponds to, for example, the NB-IoT DL L2 processing unit 132 and the NB-IoT UL L2 processing unit 133. The CPU 174 corresponds to, for example, the NB-IoT wireless scheduler 150. Further, the DSP 178 corresponds to, for example, the NB-IoT L1 processing unit 140.

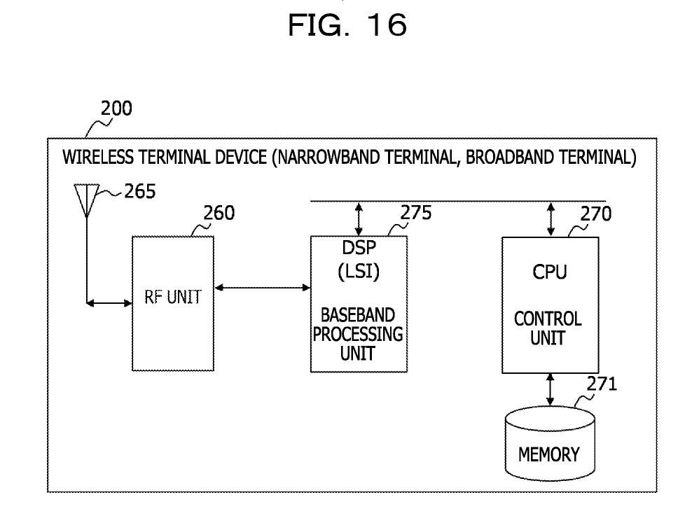

FIG. 16 illustrates hardware configuration examples of the narrowband terminal 200-1 and the broadband terminal 200-2. Because they all have the same configuration, a terminal (or a wireless terminal device, hereinafter, it may be referred to as a “terminal” in some cases) 200 will be described. The terminal 200 further includes a CPU 270, a memory 271, and a DSP 275. The CPU 270 reads and executes, for example, the program stored in the memory 271, thereby executing the functions of the control units 211-1 and 211-2 and the line control units 230-1 and 230-2, described in the second embodiment. The CPU 270 corresponds to, for example, the control units 211-1 and 211-2 and the line control units 230-1 and 230-2. Further, the DSP 275 corresponds to, for example, the baseband processing units 210-1 and 210-2 described in the second embodiment.

For the CPUs 170, 172, 174, 176, 170-1, 170-2, and 270 described above, for example, a DSP, a Micro Processing Unit (MPU), a Field-Programmable Gate Array (FPGA), a control unit, or the like may be used instead of the CPU. For the DSPs 178, 179, and 275 described above, for example, controllers or control units such as a CPU, an FPGA, and a Large Scale Integration (LSI) may be used instead of the DSP.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station apparatus comprising:
a memory; and
a processor coupled to the memory and configured to:
execute a first scheduling of allocating a first radio resource in a first frequency band used in a first wireless communication standard to a first terminal device, and
execute a second scheduling of allocating a second radio resource in a second frequency band used in a second wireless communication standard to a second terminal device, and
wherein
the second frequency band is broader than the first frequency band, and the first frequency band is included in the second frequency band,
the second scheduling is executed after the first scheduling is executed,
when the first radio resource is not allocated in the first scheduling, the first frequency band is allocated as the second radio resource in the second scheduling, and
when the first radio resource is allocated in the first scheduling, a frequency band other than the first frequency band in the second frequency band is allocated as the second radio resource in the second scheduling.

2. The base station apparatus according to claim 1, wherein
the first scheduling is executed at a regular cycle, and
the second scheduling is executed based on a result of the first scheduling executed in the regular cycle.

3. The base station apparatus according to claim 1, wherein
the processor is configured to determine an allocation amount in the first scheduling.

4. The base station apparatus according to claim 3, wherein
the allocation amount is determined based on a data transmission interval between the base station apparatus and the first terminal device.

5. The base station apparatus according to claim 3, wherein
the allocation amount is represented by the number of transmission time intervals (TTIs) between the base station apparatus and the first terminal device.

6. The base station apparatus according to claim 1, wherein
the first wireless communication standard is a Narrow band-Internet of Things (NB-IoT) wireless communication standard, and
the second wireless communication standard is a Long Term Evolution (LTE) wireless communication standard.

7. The base station apparatus according to claim 5, wherein
the number of TTIs is represent by
Σ_{uεU[t]}┌Dᵤ/d_{TTI}^{max}┐
wherein
u is a user ID,
Dᵤ is a data size of the user u,
U(t) is a set of users who perform reception in a section t, and
d_{TTI}^{max} is a size of data that can be transmitted per TTI.

8. The base station apparatus according to claim 5, wherein
the number of TTIs is represent by
$${\sum }_{u ∈ U [ t ]}^{ } ⌊ {D}_{u} / {d}_{TTI}^{ma x} ⌋ + ( {\sum }_{u ∈ U [ t ]}^{ } max ( {D}_{u} mod {d}_{TTI}^{ma x} , {d}_{TTI}^{m i n} ) ) / {d}_{TTI}^{ma x}$$
wherein
u is a user ID,
Dᵤ is a data size of the user u,
U(t) is a set of users who perform reception in a section t,
d_{TTI}^{max} is a size of data that can be transmitted per TTI, and
d_{TTI}^{min} is the minimum number of bits transmitted per TTI.

9. The base station apparatus according to claim 5, wherein
the processor is configured to:
predict generation of data in a period after an allocation amount is determined in the first scheduling until the first radio resource of the allocation amount is allocated, and
correct the allocation amount, based on a result of the prediction.

10. The base station apparatus according to claim 9, wherein
the number of TTIs is represent by
N_{TTI}^{req}[t]+ƒ(∥U(t)∥)g(τ(t))
wherein
N_{TTI}^{req}[t] is the allocation amount of the first radio resource,
f(n) is a function of the number of users nεN
∥U∥ is the number of elements of a set U,
U(t) is a set of users who perform reception in the section t,
g(τ) is a function of time τ, and
τ(t) is the time from a current time to the section t.

11. A method of allocating a radio resource executed by a base station apparatus, the method comprising:
executing a first scheduling of allocating a first radio resource in a first frequency band used in a first wireless communication standard to a first terminal device; and
after the executing of the first scheduling, executing a second scheduling of allocating a second radio resource in a second frequency band used in a second wireless communication standard to a second terminal device,
wherein
the second frequency band is broader than the first frequency band, and the first frequency band is included in the second frequency band,
when the first radio resource is not allocated in the first scheduling, the first frequency band is allocated as the second radio resource in the second scheduling, and
when the first radio resource is allocated in the first scheduling, a frequency band other than the first frequency band in the second frequency band is allocated as the second radio resource in the second scheduling.

12. The method according to claim 11, wherein
the first scheduling is executed at a regular cycle, and
the second scheduling is executed based on a result of the first scheduling executed in the regular cycle.

13. The method according to claim 11, further comprising:
in the executing of the first scheduling, determining an allocation amount.

14. The method according to claim 13, wherein
in the determining of the allocation amount, the allocation amount is determined based on a data transmission interval between the base station apparatus and the first terminal device.

15. The method according to claim 13, wherein
the allocation amount is represented by the number of transmission time intervals (TTIs) between the base station apparatus and the first terminal device.

16. The method according to claim 11, wherein
the first wireless communication standard is a Narrow band-Internet of Things (NB-IoT) wireless communication standard, and
the second wireless communication standard is a Long Term Evolution (LTE) wireless communication standard.

17. The method according to claim 15, wherein
the number of TTIs is represent by
Σ_{uεU[t]}┌Dᵤ/d_{TTI}^{max}┐
wherein
u is a user ID,
Dᵤ is a data size of the user u,
U(t) is a set of users who perform reception in a section t, and
d_{TTI}^{max} is a size of data that can be transmitted per TTI.

18. The method according to claim 15, wherein
the number of TTIs is represent by
$${\sum }_{u ∈ U [ t ]}^{ } ⌊ {D}_{u} / {d}_{TTI}^{ma x} ⌋ + ( {\sum }_{u ∈ U [ t ]}^{ } max ( {D}_{u} mod {d}_{TTI}^{ma x} , {d}_{TTI}^{m i n} ) ) / {d}_{TTI}^{ma x}$$
wherein
u is a user ID,
Dᵤ is a data size of the user u,
U(t) is a set of users who perform reception in a section t,
d_{TTI}^{max} is a size of data that can be transmitted per TTI, and
d_{TTI}^{min} is the minimum number of bits transmitted per TTI.

19. The method according to claim 15, further comprising:
predicting generation of data in a period after an allocation amount is determined in the first scheduling until the first radio resource of the allocation amount is allocated; and
correcting the allocation amount, based on a result of the prediction.

20. The method according to claim 19, wherein
the number of TTIs is represent by
N_{TTI}^{req}[t]+ƒ(∥U(t)∥)g(τ(t))
wherein
N_{TTI}^{req}[t] is the allocation amount of the first radio resource,
f(n) is a function of the number of users nεN
∥U∥ is the number of elements of a set U,
U(t) is a set of users who perform reception in the section t,
g(τ) is a function of time τ, and
τ(t) is the time from a current time to the section t.
